(19) United States
(12) Patent Application Publication
(10) Pub. No.: US 2026/0181412 A1
(43) Pub. Date: Jun. 25, 2026

(54) BEAM MANAGEMENT METHOD, DEVICE, CHIP AND STORAGE MEDIUM

(71) Applicant: CHINA SATELLITE NETWORK INNIVATION CO., LTD, Beijing (CN)

(72) Inventors: Dianting CHI, Beijing (CN); Ge MANG, Beijing (CN); Dongqing QI, Beijing (CN); Yang ZHANG, Beijing (CN)

(21) Appl. No.: 19/541,358

(22) Filed: Feb. 16, 2026

Related U.S. Application Data
(63) Continuation of application No. PCT/CN2025/120962, filed on Sep. 12, 2025.

(30) Foreign Application Priority Data
Dec. 24, 2024 (CN) 202411918379.4

(51) Int. Cl. H04W 16/28; H04B 7/185; H04B 7/204; H04W 72/044

(52) U.S. Cl. CPC H04W 16/28; H04B 7/18513; H04B 7/2041; H04W 72/046

(57) ABSTRACT

The present disclosure relates to the technical field of satellite communication, and provides a beam management method, a device, a chip, and a storage medium. The method comprises: a user equipment acquires a serving beam corresponding to a beam footprint where the user equipment is located; the serving beam is a beam corresponding to a target beam index, and each beam footprint is bound to one beam index. The embodiments of the present disclosure can avoid co-frequency interference occurring between adjacent beam footprints in different cells, and reduce the processing complexity and resource overhead caused by frequent changes of the beams at the beam footprints and frequent changes of the beam footprints in neighboring cells.

### CROSS-REFERENCE TO RELATED APPLICATIONS

The present application is a continuation of International Patent Application No. PCT/CN2025/120962, filed on Sep. 12, 2025, which claims priority to Chinese Patent Application No. 202411918379.4, filed on Dec. 24, 2024, and entitled “Beam Management Method, Device, Chip and Storage Medium”, the entire contents of which are incorporated herein by reference.

### TECHNICAL FIELD

The present disclosure relates to the technical field of satellite communication, and in particular to a beam management method, a device, a chip, and a storage medium.

### BACKGROUND

In a traditional beam management scheme of a satellite communication system, each satellite-borne base station independently deploys beam indices within its coverage area (such as a Synchronization Signal/PBCH Block (SSB) index corresponding to the beam). This beam management scheme may easily cause the following problems: (1) co-frequency interference occurs between adjacent beam footprints in different cells; (2) frequent changes of the beams at the beam footprints increase processing complexity; (3) frequent changes of the beam footprints of neighboring cells result in frequent updates to Xn and Uu interfaces.

### SUMMARY

An object of embodiments of the present disclosure is to provide a serving beam management method, an apparatus, a device, and a storage medium to solve or at least partially solve the above-mentioned technical problems.

To achieve the above object, in one aspect, embodiments of the present disclosure provide a beam management method include the following steps:
acquiring, by a user equipment, a serving beam corresponding to a beam footprint where the user equipment is located, wherein the serving beam is a beam corresponding to a target beam index in a satellite network, and each beam footprint is bound to one beam index.

In some embodiments of the present disclosure, the step of acquiring, by a user equipment, a serving beam corresponding to a beam footprint where the user equipment is located includes:
matching, by the user equipment, a target beam index corresponding to the beam footprint where the user equipment is located; and selecting, by the user equipment from a cell where the user equipment is located, a beam corresponding to the target beam index as the serving beam.

In some embodiments of the present disclosure, there is an overlapping coverage area between adjacent cells of the satellite network, a first part of beam indices of the satellite network serve as reserved beam indices for allocation to edge beam footprints corresponding to the overlapping coverage area, and a second part of beam indices of the satellite network are fixedly allocated to beam footprints in a beam deployment map.

In some embodiments of the present disclosure, there is no overlapping coverage area between adjacent cells of the satellite network, and all beam indices of the satellite network are fixedly allocated to beam footprints in a beam deployment map.

In some embodiments of the present disclosure, the beam management method further includes:
determining, by the user equipment, whether the beam footprint where the user equipment is located has entered an overlapping coverage area between the cell where the user equipment is located and a neighboring cell; and
in response to that the beam footprint where the user equipment is located has entered the overlapping coverage area between the cell where the user equipment is located and the neighboring cell, selecting, by the user equipment, a beam corresponding to a specific beam index as the serving beam, wherein the specific beam index is a beam index that the user equipment receives in the overlapping coverage area and that is within a range of the reserved beam indices.

In some embodiments of the present disclosure, the beam management method further includes:
determining, by the user equipment, whether the beam footprint where the user equipment is located has exited the overlapping coverage area between the cell where the user equipment is located and the neighboring cell;
in response to that the beam footprint where the user equipment is located has exited the overlapping coverage area between the cell where the user equipment is located and the neighboring cell, determining, by the user equipment, whether the beam footprint where the user equipment is located has changed; and
in response to that the beam footprint where the user equipment is located has not changed, re-selecting, by the user equipment, the beam corresponding to the target beam index as the serving beam.

In some embodiments of the present disclosure, the beam management method further includes:
in response to that the beam footprint where the user equipment is located has changed, determining, by the user equipment according to the beam deployment map, a new target beam index corresponding to the changed beam footprint where the user equipment is located; and
selecting, by the user equipment from the cell where the user equipment is located, a beam corresponding to the new target beam index as the serving beam.

In some embodiments of the present disclosure, the beam management method further includes:
receiving, by the user equipment, a system message transmitted by a network device of the satellite network, and the system message carrying the range of the reserved beam indices.

In some embodiments of the present disclosure, the edge beam footprints include front and/or rear edge beam footprints in a movement direction of the cell where the user equipment is located.

In some embodiments of the present disclosure, the beam deployment map is pre-configured in the user equipment.

In some embodiments of the present disclosure, the beam management method further includes:
receiving, by the user equipment, map update data transmitted by a network device of the satellite network; and
updating, by the user equipment, a local beam deployment map based on the map update data.

In some embodiments of the present disclosure, the step of acquiring, by a user equipment, a serving beam corresponding to a beam footprint where the user equipment is located includes:
receiving, by the user equipment, the serving beam designated by a network device of the satellite network for the beam footprint where the user equipment is located, wherein the target beam index is determined by the network device according to the beam footprint where the user equipment is located and a beam deployment map.

In another aspect, embodiments of the present disclosure further provide a beam management method include:
determining, by a network device according to a beam deployment map, target beam indices corresponding to beam footprints covered by its cell, wherein each beam footprint is bound to one beam index; and
transmitting, by the network device, beams according to the target beam indices.

In some embodiments of the present disclosure, there is an overlapping coverage area between adjacent cells of the satellite network, a first part of beam indices of the satellite network serve as reserved beam indices for allocation to edge beam footprints corresponding to the overlapping coverage area, and a second part of beam indices of the satellite network are fixedly allocated to beam footprints in a beam deployment map.

In some embodiments of the present disclosure, there is no overlapping coverage area between adjacent cells of the satellite network, and all beam indices of the satellite network are fixedly allocated to beam footprints in a beam deployment map.

In some embodiments of this manual, the step of transmitting, by the network device, beams according to the target beam indices includes:
transmitting, by the network device according to allocation information of the reserved beam indices, beams to the edge beam footprints covered by its cell, and transmitting, by the network device according to the target beam indices, beams to the remaining beam footprints covered by its cell.

In some embodiments of the present disclosure, the beam management method further includes:
broadcasting, by the network device, a system message to the beam footprints covered by its cell, wherein the system message carries a range of the reserved beam indices.

In some embodiments of the present disclosure, the beam management method further includes:
receiving, by the network device, map update data transmitted by a ground control center of the satellite network; and
broadcasting, by the network device, the map update data to the beam footprints covered by its cell.

In another aspect, embodiments of the present disclosure further provide a user equipment including:
at least one processor; and
at least one memory storing thereon instructions that, when executed individually or collectively by the at least one processor, cause the user equipment to execute the beam management method described above.

In another aspect, embodiments of the present disclosure further provide a network device including:
at least one processor; and
at least one memory storing thereon instructions that, when executed individually or collectively by the at least one processor, cause the network device to execute the beam management method described above.

In another aspect, embodiments of the present disclosure further provide a chip including a circuit system configured to execute the beam management method described above.

In another aspect, embodiments of the present disclosure further provide a computer storage medium storing thereon instructions that, when executed individually or collectively by at least one processor of a computer device, cause the computer device to execute the beam management method described above.

In another aspect, embodiments of the present disclosure further provide a computer program product including instructions that, when executed individually or collectively by at least one processor of a computer device, cause the computer device to execute the beam management method described above.

From the technical solutions provided in the embodiments of the present disclosure described above, it can be seen that in the embodiments of the present disclosure, the global coverage of the satellite network is divided into multiple ground-fixed beam footprints, and each beam footprint is bound to one beam index. Such information is provided in advance to the user equipment as a global beam deployment map, so that the user equipment can select a serving beam based on the beam footprint where the user equipment is located and the beam deployment map. Thus, under this globally unified beam management, each network device no longer needs to independently deploy beam indices for its own coverage area, thereby avoiding the problem of co-frequency interference caused by each network device independently deploying beam indices for its own coverage area. Moreover, since one ground-fixed beam footprint corresponds to one fixed beam footprint index and does not change with the replacement of the serving satellite, in scenarios with frequent satellite flyovers, for a stationary or low-mobility user equipment, the time-domain position of the SSB of its serving beam does not change. This reduces the complexity of processes related to beam management, network search, measurement, paging, and random access for the user equipment, and also reduces its energy consumption. In addition, because the beam index is bound to a ground-fixed beam footprint, the network device only needs to know the beam index information of its own coverage area and can then determine the beam management information of neighboring areas based on the beam deployment map, thereby avoiding the problem of frequent updates to the Xn and Uu interfaces resulting from frequent changes of beam footprints in neighboring areas.

### BRIEF DESCRIPTION OF DRAWINGS

To illustrate the technical solutions in the embodiments of the present disclosure or in the prior art more clearly, the drawings used in the embodiments or the prior art description will be briefly introduced below. Obviously, the drawings in the following description are merely some embodiments described in the present disclosure. For those of ordinary skill in the art, other drawings may be obtained from these drawings without creative effort. In the drawings:

FIG. 1 shows a schematic diagram of independently deployed beam indices in the prior art;

FIG. 2 shows a schematic diagram of a satellite communication system in some embodiments of the present disclosure;

FIG. 3 shows a flowchart of a beam management method (UE side) in some embodiments of the present disclosure;

FIG. 4 shows a flowchart of the user equipment acquiring a serving beam corresponding to a beam footprint where the user equipment is located in the beam management method shown in FIG. 3;

FIG. 5a shows a schematic diagram of allocation of reserved beam indices in an exemplary embodiment of the present disclosure;

FIG. 5b shows a schematic diagram of allocation of remaining beam indices in an exemplary embodiment of the present disclosure;

FIG. 5c shows a schematic diagram of the allocation of the reserved beam indices allocated to edge beam footprints in overlapping coverage areas in an exemplary embodiment of the present disclosure;

FIG. 6 shows a flowchart of a beam management method (UE side) in some other embodiments of the present disclosure;

FIG. 7 shows a schematic diagram of beam switching process in an exemplary embodiment of the present disclosure;

FIG. 8 shows a flowchart of a beam management method (network device side) in some embodiments of the present disclosure; and

FIG. 9 shows a structural block diagram of a computer device in some embodiments of the present disclosure.

### DESCRIPTION OF THE REFERENCE NUMERALS

10. user equipment;
20. network device;
902: computer device;
904: processor;
906: memory;
908: driving mechanism;
910: input/output interface;
912: input device;
914: output device;
916: presentation device;
918: graphical user interface;
920: network interface;
922: communication link;
924: communication bus.

### DESCRIPTION OF EMBODIMENTS

In order to make those skilled in the art better understand the technical solutions in the present disclosure, the technical solutions in the embodiments of the present disclosure will be clearly and completely described in the following with reference to the accompanying drawings in the embodiments of the present application. Obviously, the described embodiments are only a part of the embodiments of the present disclosure, but not all of them. Based on the embodiments of the present disclosure, all other embodiments obtained by persons skilled in the art without making creative efforts shall fall within the protection scope of the present disclosure.

It should be noted that in the embodiments of the present disclosure, the user information (including but not limited to user equipment information, user personal information, etc.) and data (including but not limited to data used for analysis, stored data, displayed data, etc.) involved are all information and data authorized by the user and fully authorized by all parties, i.e., the acquisition, transmission, storage, use, processing, etc. of the data in the technical solution of the present application all comply with relevant provisions of national laws and regulations.

A satellite communication system can use satellites as relay stations to forward radio waves for communication between multiple ground stations, and to achieve communication between user equipments (UEs) and between a user equipment and a satellite through the satellites and the ground stations. Among them, the user equipment can include a fixed terminal, a handheld terminal (i.e., a portable terminal), a receiver mounted on a transportation vehicle (such as a vehicle, a ship, an aircraft) for realizing satellite communication, and so on. In some embodiments of the present disclosure, the handheld terminal may include, for example, a smartphone, a satellite phone, a tablet computer, a notebook computer, a smart wearable device (such as a smart bracelet, a smart watch, smart glasses, or a smart helmet), etc. In addition, in a scenario where a satellite directly connects to a user equipment, the satellite communication system may also not include a ground station. Among them, the satellite is equipped with a communication base station (i.e. a satellite-borne base station), and both the satellite (including the satellite-borne base station) and the ground station are network devices in the satellite communication system, and can also be collectively referred to as the satellite network or the network side.

In a traditional beam management scheme of the satellite communication system, each network device (such as the satellite-borne base station) independently deploys beam indices within its coverage area. However, such beam management scheme tends to cause the following problems:

### (1) Co-Frequency Interference.

Because each network device independently deploys beam indices within its coverage area, adjacent beam footprints in different cells may be configured with the same beam index. As a result, co-frequency interference between adjacent beam footprints may occur. In order to avoid such co-frequency interference, adjacent network devices also need to coordinate their beam index deployment schemes, leading to frequent Xn interface interactions and higher processing complexity.

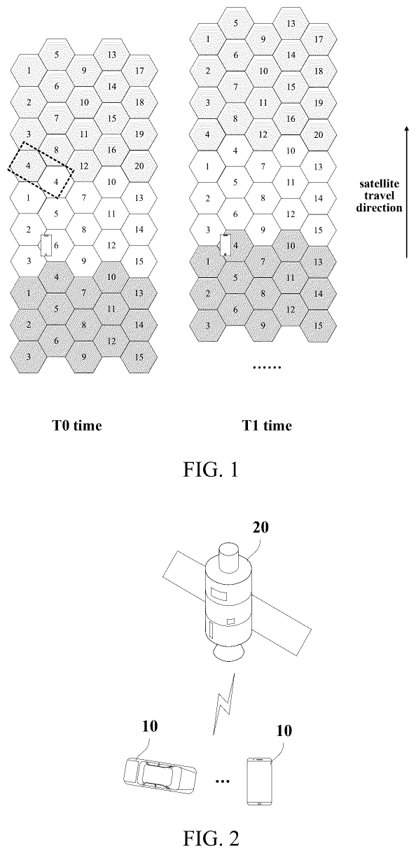

For example, in a ground area covered by three cells as shown in FIG. 1, each regular hexagon represents a beam footprint, different gray shades in FIG. 1 represent the coverage of different cells, and the numeral on each beam footprint represents the beam index corresponding to the beam covering that beam footprint. The two adjacent beam footprints within the dashed box in FIG. 1 belong to different cells but are both configured with the same beam index 4; thus, co-frequency interference will be caused.

### (2) Frequent Changes of the Beams at the Beam Footprints Increase Processing Complexity.

In the satellite communication system, one beam footprint may span tens of kilometers. Therefore, except for high-speed moving user equipment (UE) such as aircrafts, the vast majority of user equipments remain within a fixed beam footprint most of the time. Relative to the high-speed movement of the satellite, the vast majority of user equipments can be considered as stationary or low-mobility user equipments. However, even such stationary or low-mobility user equipments experience frequent cell changes due to frequent satellite flyovers.

Specifically, compared to a terrestrial communication system, in the satellite communication system (such as a low Earth orbit (LEO) satellite communication system), the coverage area of the network device is not stationary relative to the ground, but changes with the movement of the satellites. The coverage area of the network device dynamically covers the corresponding ground areas along the satellites' travel direction. When a stationary or low-mobility user equipment experiences a serving satellite change, the beam corresponding to its beam footprint in the original cell is likely inconsistent with the beam corresponding to its beam footprint in the new cell, thus requiring beam re-deployment. In short, under the traditional beam management scheme, the coverage of network devices changes over short periods, necessitating re-deployment of beams within their coverage, which in turn leads to frequent beam changes. Frequent beam changes not only increase the processing complexity for network devices but also increase the complexity for user equipments in processes such as beam management, network search, measurement, paging, random access, and other related procedures.

For example, in FIG. 1, at time T0, the user equipment is located within the beam footprint corresponding to the beam index 6 in the middle cell (white area), and at the next time T1, the user equipment switches to the beam footprint corresponding to the beam index 4 in the lower cell (dark gray area).

### (3) Frequent Changes of the Beam Footprints of Neighboring Cells Result in Frequent Updates to Xn and Uu Interfaces.

In the traditional beam management scheme, as the cell shape may also continuously change during satellite travel, the adjacency relationships of beam indices at the boundaries of adjacent cells also keep changing. The network device side consequently needs to frequently update these changes via the Xn and Uu interfaces.

In view of this, and in order to solve the above problems, the present disclosure provides an improved beam management scheme, which can be applied to a user equipment 10 of a low-orbit satellite communication system, and can also be applied to medium- and high-orbit satellite communication systems.

FIG. 2 shows a schematic diagram of a satellite communication system according to some embodiments of the present disclosure. The satellite communication system includes a user equipment 10 and a network device 20. The user equipment 10 can communicate with the network device 20. Among them, the user equipment 10 can include a handheld user equipment (i.e., a portable user equipment), a receiver mounted on a transportation vehicle (such as a vehicle, a ship, an aircraft) for realizing satellite communication, and other terminal equipments. In some embodiments of the present disclosure, the handheld user equipment may include, for example, a smartphone, a satellite phone, a tablet computer, a laptop computer, a smart wearable device (such as a smart bracelet, a smart watch, smart glasses, or a smart helmet), etc. The network device 20 can be a network device 20 in a low-orbit satellite communication system or a network device 20 in medium- and high-orbit satellite communication systems.

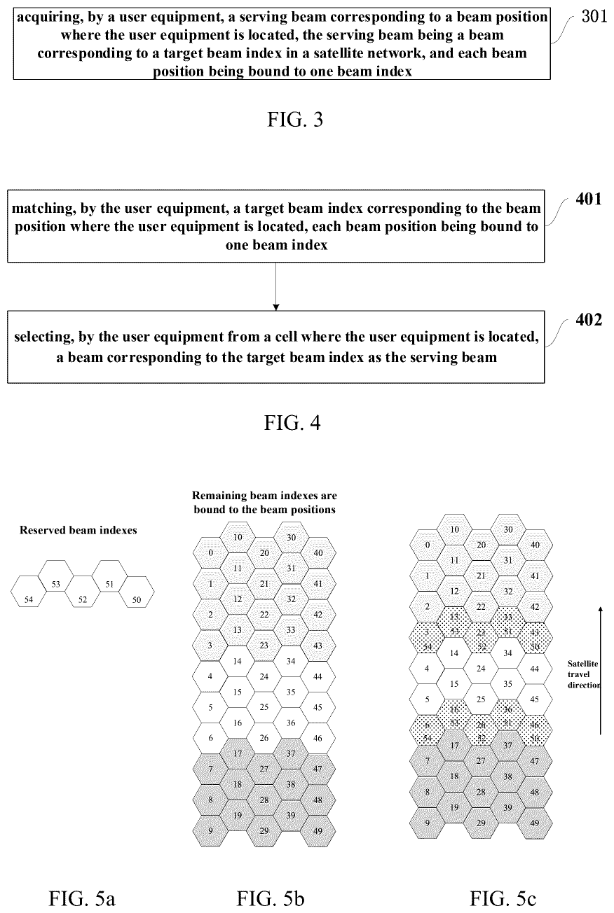

One embodiment of the present disclosure provides a beam management method, which can be applied to the user equipment side as described above. Referring to FIG. 3, in some embodiments of the present disclosure, the beam management method on the user equipment side may include the following steps:

Step 301: acquiring, by a user equipment, a serving beam corresponding to a beam footprint where the user equipment is located, wherein the serving beam is a beam corresponding to a target beam index in a satellite network, and each beam footprint is bound to one beam index.

In the embodiments of the present disclosure, the global coverage of the satellite network is divided into multiple ground-fixed beam footprints (the beam footprints do not change with different satellites flyovers but are fixed relative to the ground), and each beam footprint is bound to one beam index. Such information is provided to the user equipment in advance as a global beam deployment map, so that the user equipment can select a serving beam based on the beam footprint where the user equipment is located and the beam deployment map. Thus, under such global unified beam management, each network device no longer needs to independently deploy beam indices for its own coverage area, thereby avoiding the problem of co-frequency interference caused by each network device independently deploying beam indices for its own coverage area.

In the embodiments of the present disclosure, since one ground-fixed beam footprint corresponds to one fixed beam footprint index and does not change with the replacement of the serving satellite, in this way, in scenarios with frequent satellite flyovers, for a stationary or low-mobility user equipment, the time-domain position of the SSB of its serving beam does not change. This reduces the complexity of processes related to beam management, network search, measurement, paging, and random access for the user equipment, and also reduces the energy consumption of the user equipment.

In the embodiments of the present disclosure, because the beam footprint index is bound to a ground-fixed beam footprint, the network device only needs to know the beam index information of its own coverage area, and can then determine the beam management information of neighboring areas based on the beam deployment map. This avoids the problem of frequent updates to the Xn and Uu interfaces caused by frequent changes of beam footprints in neighboring areas.

Referring to FIG. 4, in some embodiments of the present disclosure, the user equipment acquires a serving beam corresponding to a beam footprint where the user equipment is located, which may include the following steps:

Step 401: matching, by the user equipment, a target beam index corresponding to the beam footprint where the user equipment is located, wherein each beam footprint is bound to one beam index.

In some embodiments of the present disclosure, the user equipment can match the target beam index corresponding to the beam footprint where the user equipment is located from the beam deployment map of the satellite network. In the beam deployment map, the global coverage of the satellite network is divided into multiple ground-fixed beam footprints, and each beam footprint is bound to one beam index.

Step 402: selecting, by the user equipment from a cell where the user equipment is located, a beam corresponding to the target beam index as the serving beam.

In some other embodiments of the present disclosure, the user equipment acquires a serving beam corresponding to a beam footprint where the user equipment is located, which may include: the user equipment receives the serving beam designated by the network device of the satellite network for the beam footprint where the user equipment is located. Here, the serving beam is a beam corresponding to a target beam index, and the target beam index is determined by the network device based on the beam footprint where the user equipment is located and the beam deployment map. The network device of the satellite network can acquire the beam footprint and the cell where the user equipment is located. On this basis, the network device can match the target beam index corresponding to the beam footprint where the user equipment is located from the beam deployment map of the satellite network, and then designate the beam corresponding to that target beam index from the cell where the user equipment is located as the serving beam for that user equipment at that beam footprint. In addition, if there are other user equipments in that beam footprint, the beam corresponding to the target beam index can also be used as the serving beam for those other user equipments in that beam footprint.

In the embodiments of the present disclosure, the beam deployment map of a satellite network refers to the beam deployment map of a specific satellite network; the global coverage of a satellite network refers to the global coverage of a specific satellite network. For example, taking the Starlink satellite network as an example, in the beam deployment map of the Starlink satellite network, the global coverage of the Starlink satellite network is divided into multiple ground-fixed beam footprints, and each beam footprint is bound to one fixed beam index.

In the embodiments of the present disclosure, a cell refers to the signal coverage of a satellite-borne base station. The cell where the user equipment is located refers to the cell where the user equipment is currently located (i.e., the current serving cell of the user equipment).

In the embodiments of the present disclosure, a beam refers to a specific shape formed in space by electromagnetic waves emitted by a satellite-borne base station; a serving beam refers to the beam currently used by the user equipment in the satellite network.

It should be noted that in the embodiments of the present disclosure, the beam footprint is a fixed area range on the ground, and this fixed area does not change with the replacement of the serving cell or satellite. The beam footprint where the user equipment is located refers to the beam footprint where the user equipment is currently located. If the current location of the user equipment is within the coverage of the beam footprint, then that beam footprint is the beam footprint where the user equipment is located. The target beam index corresponding to the beam footprint where the user equipment is located refers to the beam index that corresponds to that beam footprint where the user equipment is located in the beam deployment map. For example, if the beam footprint where the user equipment is located is beam footprint A, and the corresponding beam index of the beam footprint A in the beam deployment map is beam footprint index X, then the beam footprint index X is the target beam index corresponding to the beam footprint where the user equipment is located.

In the embodiments of the present disclosure, the beam index refers to an SSB Index corresponding to the beam, which is an identifier for the time-frequency location of the SSBs, that is, the beam index is in correspondence to the beam in the time-frequency resources. Here, the SSB stands for Synchronization Signal/PBCH Block, which includes synchronization signals and broadcast signals. The SSB includes a Primary Synchronization Signal (PSS), a Secondary Synchronization Signal (SSS), and a Physical Broadcast Channel (PBCH), which together implement functions such as cell search, timing and frequency synchronization, location and mobility management, as well as access and measurement, and the like, providing stable and reliable communication service for the user equipment.

In some embodiments of the present disclosure, for application scenarios where there is an overlapping coverage area between adjacent cells of the satellite network, a part of beam indices supported by the satellite network serve as reserved beam indices for allocation to edge beam footprints corresponding to the overlapping coverage area; while the remaining beam indices of the satellite network are fixedly allocated to the beam footprints in the beam deployment map. In this way, in an overlapping coverage scenario, the beams corresponding to the edge beam footprints corresponding to the overlapping coverage areas between adjacent cells will not frequently change simply because the overlapping coverage areas dynamically cover different ground beam footprints, which is conducive to further reducing the processing complexity of beam management.

For example, in the exemplary embodiments shown in FIGS. 5a to 5c, the global coverage of the satellite network is divided into fifty ground-fixed beam footprints, and beam footprint indices 0 to 49 supported by the satellite network are fixedly allocated to these fifty ground-fixed beam footprints (as shown in FIG. 5b). In FIG. 5b, the first ground-fixed beam footprint in the first column is fixedly allocated a beam footprint index 0 (i.e., the first ground-fixed beam footprint in the first column is bound to the beam footprint index 0), and the second ground-fixed beam footprint in the first column is fixedly allocated a beam footprint index 1 (i.e., the second ground-fixed beam footprint in the first column is bound to the beam footprint index 1), and so on. The beam footprint indices 50 to 54 supported by the satellite network are reserved as reserved beam indices (as shown in FIG. 5a), which are to be allocated to edge beam footprints corresponding to the overlapping coverage areas (as shown in FIG. 5c). In FIG. 5c, the uppermost row of beam footprints filled with black dots are the edge beam footprints corresponding to the overlapping coverage area between the middle cell and the upper cell, and this row of edge beam footprints is allocated beam footprint indices 55 to 50 from left to right.

In the embodiments of the present disclosure, there may be two beams covering the same beam footprint in an overlapping coverage area (one being the beam corresponding to the beam index fixedly allocated according to the beam deployment map, and the other being a beam corresponding to the reserved beam index). However, since the two beams covering the same beam footprint use different beam indices, these two beams generally are not transmitted to the beam footprint at the same time, and thus there is no signal interference.

In some embodiments of the present disclosure, the regular hexagon shape for a beam footprint is provided only as an example; in other embodiments of the present disclosure, a beam footprint can also have rectangular, circular, or elliptical shapes.

In some embodiments of the present disclosure, the edge beam footprints include the front and/or rear edge beam footprints in the movement direction of the cell where the user equipment is located. The first row of beam footprints at the front and the first row at the rear in the movement direction of the cell experience the most frequent switchings. Therefore, designating the edge beam footprints as the front and/or rear edge beam footprints in the cell's movement direction is beneficial for achieving service continuity.

In addition, the left edge beam footprints and the right edge beam footprints of a cell may also become switching beam footprints due to the movement of the user equipment or the Earth's rotation, but this switching frequency is relatively lower. Therefore, in some embodiments of the present disclosure, the edge beam footprints on both sides may not have overlapping coverage. In this scenario, the user equipment can complete the switching by measuring signals leaked from neighboring cells. Of course, in some other embodiments of the present disclosure, overlapping coverage may also be optionally configured for the edge beam footprints on both sides as needed.

Of course, in some other embodiments of the present disclosure, for application scenarios in which there is no overlapping coverage area between adjacent cells of the satellite network, all beam indices supported by the satellite network can be fixedly allocated to the beam footprints in the beam deployment map.

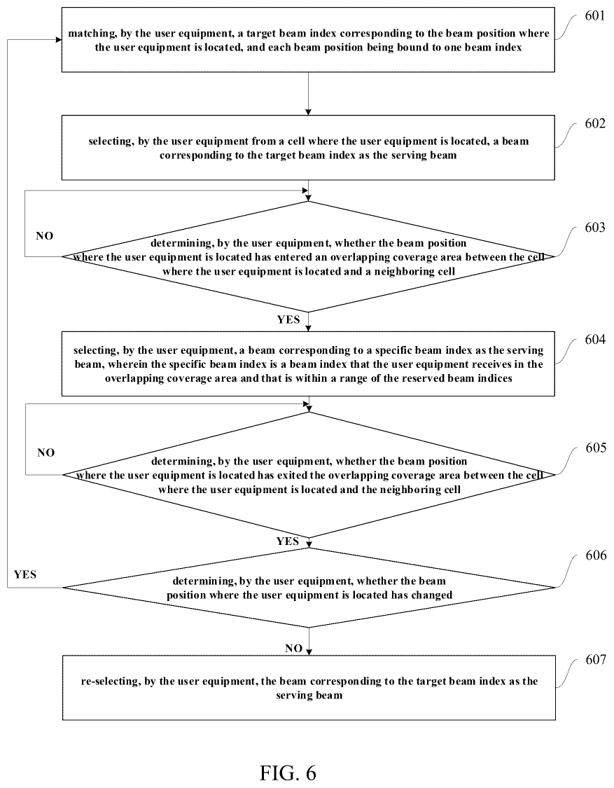

Embodiment of the present disclosure provides another beam management method, which can be applied to the user equipment side as described above. Referring to FIG. 6, in some embodiments of the present disclosure, the beam management method on the user equipment side may include the following steps:

Step 601: matching, by the user equipment, the target beam index corresponding to the beam footprint where the user equipment is located, wherein each beam footprint is bound to one beam index.

In some embodiments of the present disclosure, the user equipment can match the target beam index corresponding to the beam footprint where the user equipment is located from the beam deployment map of the satellite network; in the beam deployment map, the global coverage of the satellite network is divided into multiple ground-fixed beam footprints, and each beam footprint is bound to one beam index.

Step 602: selecting, by the user equipment, a beam corresponding to the target beam index from a cell where the user equipment is located as a serving beam.

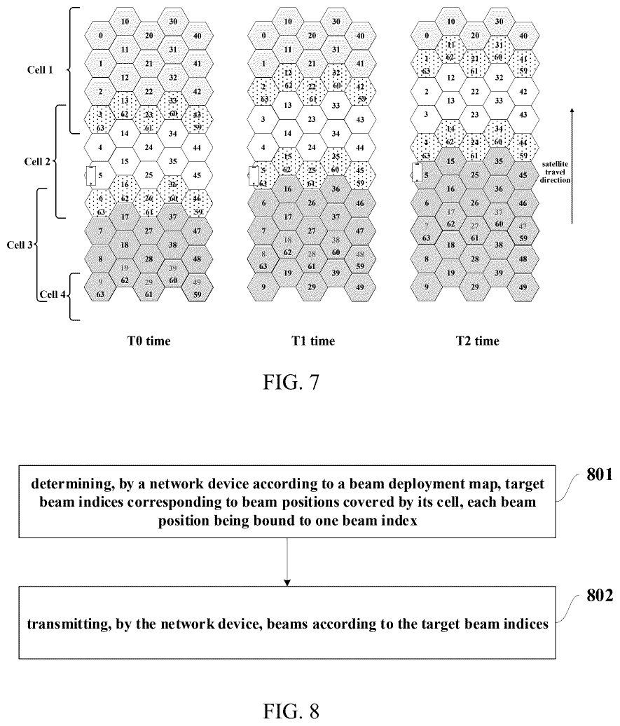

For example, in the exemplary embodiment shown in FIG. 7, at time T0, according to the beam deployment map, a mobile terminal is located within the beam footprint marked with the numeral 5 (i.e., the beam index 5) in Cell 2. This beam footprint is the beam footprint where the mobile terminal is located, and Cell 2 is the cell where the mobile terminal is located. At time TO, the mobile terminal can select the beam corresponding to the beam index 5 of Cell 2 as the serving beam.

Step 603: determining, by the user equipment, whether the beam footprint where the user equipment is located has entered an overlapping coverage area between the cell where the user equipment is located and a neighboring cell.

If the beam footprint where the user equipment is located has entered the overlapping coverage area between the cell where the user equipment is located and a neighboring cell, then Step 604 is performed; otherwise, it may continue to determine whether the beam footprint where the user equipment is located has entered an overlapping coverage area between the cell where the user equipment is located and a neighboring cell (for example, when the next determination opportunity arises, it may again determine whether the beam footprint where the user equipment is located has entered an overlapping coverage area between the cell where the user equipment is located and a neighboring cell).

In some embodiments of the present disclosure, the user equipment is generally a stationary or low-mobility user equipment (relative to the ground). In this scenario, “entering” refers to the following: as the satellite advances, the cell moves relative to the user equipment and the beam footprint where the user equipment is located, causing the user equipment and the beam footprint where the user equipment is located to move into the dynamic coverage of the cell. If the user equipment is a high-mobility user equipment (such as an aircraft or the like), the combined movement of the user equipment and the cell may also cause the user equipment and the beam footprint where the user equipment is located to move into the dynamic coverage of the cell.

Step 604: selecting, by the user equipment, a beam corresponding to a specific beam index as the serving beam; wherein the specific beam index is a beam index that the user equipment receives in the overlapping coverage area and that is within the reserved beam index range.

For example, in the exemplary embodiment shown in FIG. 7, at time T0, the mobile terminal receives service within the beam footprint of the beam index 5 in Cell 2. As the satellite moves forward, at time T1, the beam footprint is covered simultaneously by Cell 3 and Cell 2. At this time, the mobile terminal can not only receive an SSB with the beam index 5, but also receive an SSB with the beam index 63, that is, the user equipment enters the overlapping coverage area between Cell 2 and its adjacent Cell 3. Since the beam index 63 is within the range of the reserved beam indices (59 to 63), at time T1, the mobile terminal can select the beam corresponding to the beam index 63 of Cell 3 as the serving beam, that is, switch the serving beam to the beam corresponding to beam index 63 of Cell 3.

Thus, in some embodiments of the present disclosure, the user equipment can perform neighboring cell detection, measurement, and switching only within a time-domain window corresponding to the reserved beam index range. In this way, the purpose of reducing the power consumption of the user equipment during neighboring cell measurement can be achieved.

In some embodiments of the present disclosure, due to the use of overlapping coverage, the user equipment has more time to complete the switching process during beam switching, which can to some extent reduce or avoid the impact of the beam switching on service continuity, thereby improving the user experience.

S605: determining, by the user equipment, whether the beam footprint where the user equipment is located has entered an overlapping coverage area between the cell where the user equipment is located and a neighboring cell.

If the beam footprint where the user equipment is located has exited the overlapping coverage area between the cell where the user equipment is located and a neighboring cell, then Step 606 is performed; otherwise, it may continue to determine whether the beam footprint where the user equipment is located has exited the overlapping coverage area between the cell where the user equipment is located and a neighboring cell (for example, when the next determination opportunity arises, it may again determine whether the beam footprint where the user equipment is located has exited the overlapping coverage area between the cell where the user equipment is located and a neighboring cell).

In some embodiments of the present disclosure, the user equipment is generally a stationary or low-mobility user equipment (relative to the ground). In this scenario, the exiting refers to the following: as the satellite advances, the cell moves relative to the user equipment and the beam footprint where the user equipment is located, causing the user equipment and the beam footprint where the user equipment is located to move out of the dynamic coverage of the cell. If the user equipment is a high-mobility user equipment, the combined movement of the user equipment and the cell may also cause the user equipment and the beam footprint where the user equipment is located to move out of the dynamic coverage area of the cell.

Step 606: determining, by the user equipment, whether the beam footprint where the user equipment is located has changed. If the beam footprint where the user equipment is located has not changed, then Step 607 is performed; otherwise, Step 601 is performed.

In some embodiments of the present disclosure, determining whether the beam footprint where the user equipment is located has changed refers to: determining whether the beam footprint where the user equipment is located at the current time and the beam footprint where the user equipment was located at the previous time are the same beam footprint.

Step 607: re-selecting, by the user equipment, the beam corresponding to the target beam index as the serving beam.

For example, in the exemplary embodiment shown in FIG. 7, at time T1, the user equipment enters the overlapping coverage area between Cell 2 and its adjacent Cell 3, and the mobile terminal switches the serving beam to the beam corresponding to the beam index 63 of Cell 3. As the satellite continues to move forward, at time T2, the mobile terminal exits the overlapping coverage area between Cell 2 and its adjacent Cell 3, that is, the mobile terminal is now only within the coverage area of Cell 3. Since the beam footprint where the mobile terminal is located at time T2 is the same as that at time T1, that is, the beam footprint where the mobile terminal is located has not changed, it can continue to use the measurement configuration for beam index 5 stored previously (i.e., switch the serving beam to the beam corresponding to beam index 5 of Cell 3) without performing measurement configuration again, thereby greatly reducing the terminal's measurement overhead and saving air interface resources.

In some embodiments of the present disclosure, the beam deployment map can be pre-configured in the user equipment; for example, configured when the user equipment leaves the factory. Subsequently, if there is an update to the beam deployment map, the ground control center can provide the update to the satellite-borne base station, which can then provide it to the user equipment via over the air (OTA) technology or other means. Therefore, in some embodiments of the present disclosure, the beam management method on the user equipment side may further include: the user equipment receives map update data transmitted by the network device of the satellite network; the user equipment updates its local beam deployment map based on the map update data.

In some other embodiments of the present disclosure, the user equipment is not configured with a beam deployment map when it leaves the factory. Later, the ground control center provides the beam deployment map to the satellite-borne base station at an appropriate time, and then the base station provides the beam deployment map to the user equipment via over the air (OTA) technology or other means.

In some embodiments of the present disclosure, the range of the reserved beam indices may be provided by a network device of the satellite network through a system message. Therefore, in some embodiments of the present disclosure, the beam management method on the user equipment side may further include: the user equipment receives a system message transmitted by a network device of the satellite network; and the system message carries the range of the reserved beam indices. In this way, by adding an indication in the system information to inform the terminal of the range of the reserved beam indices, a common understanding of the beam footprints in the overlapping coverage area between the user terminal and the network side can be achieved at low cost.

In some embodiments of the present disclosure, the range of the reserved beam indices can be represented by ReserveSSBIndexBoundary. For example, [0, a] can be used to represent the range of the reserved beam indices, while the remaining (a, b] can be bound to the ground-fixed beam footprints in a fixed allocation manner. Here, a is a boundary value, and b is an upper limit of the beam index supported by the system. Of course, (a, b] can be used to represent the range of the reserved beam indices, while the remaining [0, a] can be bound to the ground-fixed beam footprints in a fixed allocation manner. Therefore, the present disclosure does not limit which beam indices are selected as the range of the reserved beam indices, which can be set by the system itself.

In some embodiments of the present disclosure, a one-byte indication can be added to the message element of the system message to indicate the range of the reserved beam indices. For example, the following indication can be added to the local-star configuration of the system message SIB19:
ReserveSSBIndexBoundary-vxxx INTEGER (0 . . . 63) OPTIONAL—Need R

In the above indication, the range of the reserved beam indices is 0 to 63. Of course, using the system message SIB19 to carry the range of the reserved beam indices is merely used as an illustrative example. In other embodiments of the present disclosure, it is also possible to select system messages such as SIB1, SIB2, or SIB4 carrying the range of the reserved beam indices as needed, which is not limited in the present disclosure.

In some embodiments of the present disclosure, the user equipment can identify whether it has entered the overlapping coverage by determining whether, within the beam footprint where the user equipment is located, it has received beams corresponding to two different beam indices, with one of the beam indices being within the range of reserved beam indices. In this way, only a one-byte extension of the system message is needed to indicate the range of the reserved beam indices, which enables the user equipment to easily determine whether it has entered an overlapping coverage area, thereby completing measurement, configuration, and switching. Compared with the prior art where entry into an overlapping coverage area is determined based on cell signal strength, the UE's distance from a reference point, etc., the embodiments of the present disclosure are not affected by the near-far effect in satellite communication, nor do they rely on the shape of the cell, and are more beneficial for beam switching of stationary or low-speed user equipment in scenarios with frequent satellite flyovers.

Embodiments of the present disclosure provide another beam management method that can be applied to the network device side as described above. Referring to FIG. 8, in some embodiments of the present disclosure, the beam management method on the network device side may include the following steps:

Step 801: determining, by a network device according to a beam deployment map, target beam indices corresponding to beam footprints covered by its cell, wherein each beam footprint is bound to one beam index.

In some embodiments of the present disclosure, in the beam deployment map, the global coverage of the satellite network to which the network device belongs is divided into multiple ground-fixed beam footprints, and each beam footprint is bound to one beam index.

Step 802: transmitting, by the network device, beams according to the target beam indices.

For example, taking the exemplary embodiment shown in FIG. 5b as an example, according to the beam deployment map shown in FIG. 5b (the numeral in each beam footprint in FIG. 5b is the beam footprint index bound correspondingly to each beam footprint), if the cell coverage of a satellite-borne base station at a certain time is the white beam footprints in FIG. 5b, the satellite-borne base station can transmit beams to each white beam footprint according to the beam footprint index bound to the each white beam footprint. For example, the satellite-borne base station can transmit a beam corresponding to the beam footprint index 4 to the white beam footprint corresponding to the beam footprint index 4, transmit a beam corresponding to the beam footprint index 5 to the white beam footprint corresponding to the beam footprint index 5, and transmit a beam corresponding to the beam footprint index 14 to the white beam footprint corresponding to the beam footprint index 14, and so on.

Based on the network device determining the target beam indices for the beam footprints covered by its cell according to the beam deployment map and transmitting beams according to the target beam indices, the user equipment can match the beam index corresponding to the beam footprint where the user equipment is located from the beam deployment map, and selects the beam corresponding to that beam index from the cell where the user equipment is located as the serving beam.

In the beam management method on the network device side in some embodiments of the present disclosure, there is an overlapping coverage area between adjacent cells of the satellite network; a part of beam indices of the satellite network serve as reserved beam indices for allocation to edge beam footprints corresponding to the overlapping coverage area; and the remaining beam indices of the satellite network are fixedly allocated to the beam footprints in the beam deployment map.

In the beam management method on the network device side in some embodiments of the present disclosure, there is no overlapping coverage area between the adjacent cells of the satellite network; all beam indices of the satellite network are fixedly allocated to the beam footprints in the beam deployment map.

In the beam management method on the network device side in some embodiments of the present disclosure, for scenarios in which there is an overlapping coverage area between adjacent cells of the satellite network, the step of transmitting, by the network device, the beam based on the target beam index may include:
transmitting, by the network device according to allocation information of the reserved beam indices, beams to the edge beam footprints covered by its cell, and transmitting, by the network device according to the target beam indices, beams to the remaining beam footprints covered by its cell.

For example, taking the exemplary embodiment shown in FIG. 5c as an example, according to the beam deployment map shown in FIG. 5c (the numeral in each beam footprint in FIG. 5b is the beam footprint index bound correspondingly to each beam footprint), if the cell coverage of a satellite-borne base station at a certain time is the dark gray beam footprints and their edge beam footprints in FIG. 5C (a row of beam footprints filled with black dots that are adjacent to the dark gray beam footprints). Then:
the satellite-borne base station can transmit beams to each edge beam footprint according to the beam footprint index bound to the each edge beam footprint. For example, the satellite-borne base station can transmit a beam corresponding to the beam footprint index 54 to the edge beam footprint corresponding to the beam footprint index 54, and transmit a beam corresponding to the beam footprint index 53 to the edge beam footprint corresponding to the beam footprint index 53, and so on.

The satellite-borne base station can also transmit beams to each dark gray beam footprint according to the beam footprint index bound to the each dark gray beam footprint. For example, the satellite-borne base station can transmit a beam corresponding to the beam footprint index 7 to the dark gray beam footprint corresponding to the beam footprint index 7, transmit a beam corresponding to the beam footprint index 17 to the dark gray beam footprint corresponding to the beam footprint index 17, and transmit a beam corresponding to the beam footprint index to the dark gray beam footprint corresponding to the beam footprint index 8, and so on.

The beam management method on the network device side in some embodiments of the present disclosure may further include:
broadcasting, by the network device, a system message to the beam footprints covered by its cell, wherein the system message carries a range of the reserved beam indices.

The beam management method on the network device side in some embodiments of the present disclosure may further include:
receiving, by the network device, map update data transmitted by a ground control center of the satellite network; and
broadcasting, by the network device, the map update data to the beam footprints covered by its cell.

Embodiments of the present disclosure further provide a chip including a circuit system configured to execute the beam management method described above.

Although the process flows described above include multiple operations occurring in a particular order, it should be understood that these processes may include more or fewer operations, and these operations may be performed sequentially or in parallel (e.g., using a parallel processor or a multi-threaded environment).

For the convenience of description, when the above-mentioned device is described, it is divided into various units based on their functions and described separately. Of course, the functions of the various units may be realized in the same one or more software and/or hardware components when the present disclosure is implemented.

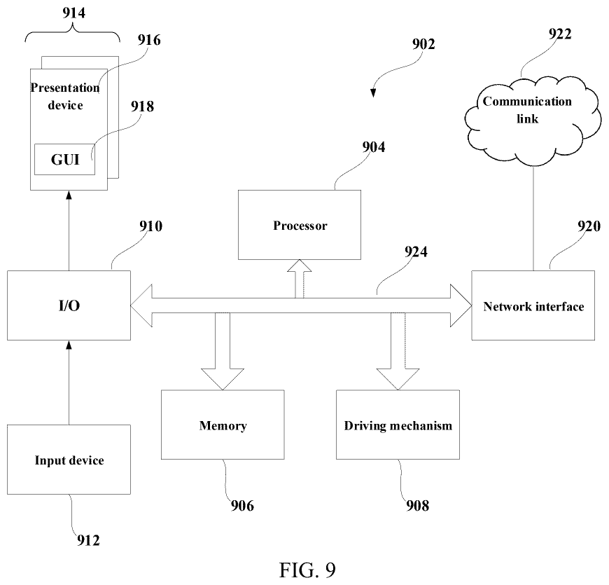

Embodiment of the present disclosure further provide a computer device. As shown in FIG. 9, in some embodiments of the present disclosure, the computer device 902 may include one or more processors 904, such as one or more central processing units (CPUs) or a graphics processing unit (GPU), each of which may implement one or more hardware threads. The computer device 902 may also include any memory 906 for storing any kind of information, such as code, settings, data, or the like, and in a specific embodiment, a computer program that is stored in the memory 906 and can run on the processor 904, which may execute instructions for the beam management method on the user equipment side described in any of the above embodiments when the computer device is a user equipment and the computer program is run by the processor 904; when the computer device is a network device (such as a satellite-borne base station), the computer program may execute instructions for the beam management method on the network device side described in any of the above embodiments when it is executed by the processor 904. By way of non-limiting examples, the memory 906 may include any one or more of the following: any type of RAM, any type of ROM, a flash device, a hard disk, an optical disk, or the like. More generally, any memory may use any technique to store information. Further, any memory may provide volatile or non-volatile retention of information. Further, any memory may represent a fixed or removable component of the computer device 902. In one scenario, when the processor 904 executes associated instructions stored in any memory or combination of the memories, the computer device 902 may perform any of the operations of the associated instructions. The computer device 902 also includes one or more driving mechanisms 908 for interacting with any memory, such as a hard disk driving mechanism, an optical disk driving mechanism or the like.

The computer device 902 may also include an input/output interface 910 (I/O) for receiving various inputs (via an input device 912) and for providing various outputs (via an output device 914). One particular output mechanism may include a presentation device 916 and an associated graphical user interface (GUI) 918. In other embodiments, the input/output interface 910 (I/O), the input device 912, and the output device 914 may also be omitted, as just one computer device in the network. The computer device 902 may also include one or more network interfaces 920 for exchanging data with other devices via one or more communication links 922. One or more communication buses 924 couple the components described above together.

The communication link 922 may be implemented in any manner, for example, via a local area network, a wide area network (e.g., the Internet), a point-to-point connection, or the like, or any combination thereof. The communication link 922 may include any combination of hardwired links, wireless links, routers, gateway functions, name servers, etc., governed by any protocol or combination of protocols.

The present application is described with reference to flowchart(s) and/or block diagram(s) of the method, the device (system), the computer-readable storage medium and the computer program product according to some embodiments of the present disclosure. It should be understood that each flow and/or block in the flowchart(s) and/or block diagram(s), and the combination of flows and/or blocks in the flowchart(s) and/or block diagram(s), can be implemented by computer program instructions. These computer program instructions can be provided to the processor of a general-purpose computer, a special-purpose computer, an embedded processor or other programmable data processor to produce a machine, so that the instructions executed by the processor of the computer or other programmable data processor create means for implementing the functions specified in one or more flows of the flowchart(s) and/or one or more blocks of the block diagram(s).

These computer program instructions can also be stored in a computer-readable memory that can direct a computer or other programmable data processor to operate in a particular manner, so that the instructions stored in the computer-readable memory produce an article of manufacture including instruction means which implement the functions specified in one or more flows of the flowchart(s) and/or one or more blocks of the block diagram(s).

These computer program instructions can also be loaded on a computer or other programmable data processor, on which a series of operation steps are executed to generate processing achieved by the computer, so that the instruction executed on the computer or other programmable data processing device is provided for being used in the steps of achieving functions designated in one or more flows of the flowchart(s) and/or one or more blocks of the block diagram(s).

In a typical configuration, the computer device includes one or more processors (CPUs), input/output interfaces, network interfaces, and a memory.

The memory may include, in the form of non-persistent storage within a computer-readable medium, Random Access Memory (RAM) and/or non-volatile memory, such as Read-Only Memory (ROM) or flash RAM. The memory is an example of a computer-readable medium.

The computer-readable medium includes permanent and non-permanent, removable and non-removable media, which can realize the information storage in any method or technique. The information can be computer readable instructions, data structures, program modules or other data. An example of the computer storage medium includes, but not limited to, a phase change memory (PRAM), a static random access memory (SRAM), a dynamic random access memory (DRAM), other types of random access memory (RAM), a read-only memory (ROM), an electrically-erasable programmable read-only memory (EEPROM), a flash memory or other memory techniques, a compact disk read only memory (CD-ROM), a digital versatile disc (DVD) or other optical storages, magnetic cassette tapes, disk storage or other magnetic storage device, or any other non-transmission medium, which can be used for the storage of information accessible to a computing device. According to the definitions in the disclosure, the computer readable medium does not include any temporary computer readable media (transitory media), such as modulated data signal and carrier wave.

Those skilled in the art should understand that the embodiments of the present disclosure can be provided as a method, a system or a computer program product. Therefore, the embodiments of the present disclosure can adopt the form of a complete hardware embodiment, a complete software embodiment, or an embodiment combining software and hardware aspects. Moreover, the embodiments of the present disclosure can adopt the form of a computer program product implemented on one or more computer-usable storage media (including but not limited to disk storage, CD-ROM, optical storage, etc.) having computer-usable program code embodied therein.

Embodiments of the present disclosure may be described in the general context of computer executable instructions executed by the computer, e.g., the program module. In general, the program module includes a routine, a program, an object, a component, a data structure, etc. executing a particular task or realizing a particular abstract data type. The embodiments of the present disclosure may also be put into practice in the distributed computing environments where tasks are executed by remote processors connected through a communication network. In the distributed computing environments, the program modules may be located in the local and remote computer storage medium including the storage device.

It should also be understood that in the embodiments of the present disclosure, the term “and/or” is merely an association relationship describing an associated object, indicating that three relationships may exist. For example, “A and/or B” may indicate the following three situations: A exists alone, both A and B exist, and B exists alone. In addition, the character “/” in this document generally indicates that the associated objects are in an “OR” relationship.

The various embodiments in the disclosure are described in a progressive manner, and the same or similar parts between the various embodiments may be referred to each other, and each embodiment focuses on the differences from the other embodiments. In particular, the system embodiment is simply described since it is substantially similar to the method embodiment, and please refer to the description of the method embodiment for the relevant content.

In the description, reference terms “one embodiment”, “some embodiments”, “example”, “specific example” or “some examples” are used to mean that specific features, structures, materials or characteristics described by combining the embodiment or example are included in at least one embodiment or example in the embodiments of the present disclosure. In the present disclosure, exemplary expression of the above terms does not necessarily refer to the same embodiment or example. Moreover, the described specific features, structures, materials or characteristics may be combined in a suitable manner in any one or more of the embodiments or examples. Furthermore, those skilled in the art can combine different embodiments or examples described in the present disclosure and features of the different embodiments or examples in the case that they are not contradictory to each other.

The above descriptions are only embodiments of the present application and are not intended to limit the application. Various changes and modifications can be made to the present application by those skilled in the art. Any modifications, equivalents, improvements, etc. made within the spirit and scope of the present application are intended to be included within the scope of the claims of the present application.

1. A beam management method, comprising:
acquiring, by a user equipment, a serving beam corresponding to a beam footprint where the user equipment is located, wherein the serving beam is a beam corresponding to a target beam index in a satellite network, and each beam footprint is bound to one beam index.

2. The beam management method according to claim 1, wherein the step of acquiring, by a user equipment, the serving beam corresponding to the beam footprint where the user equipment is located comprises:
matching, by the user equipment, a target beam index corresponding to the beam footprint where the user equipment is located; and
selecting, by the user equipment from a cell where the user equipment is located, a beam corresponding to the target beam index as the serving beam.

3. The beam management method according to claim 2, wherein there is an overlapping coverage area between adjacent cells of the satellite network, a first part of beam indices of the satellite network serve as reserved beam indices for allocation to edge beam footprints corresponding to the overlapping coverage area, and a second part of beam indices of the satellite network are fixedly allocated to beam footprints in a beam deployment map.

4. The beam management method according to claim 2, wherein there is no overlapping coverage area between adjacent cells of the satellite network, and all beam indices of the satellite network are fixedly allocated to beam footprints in a beam deployment map.

5. The beam management method according to claim 3, further comprising:
determining, by the user equipment, whether the beam footprint where the user equipment is located has entered an overlapping coverage area between the cell where the user equipment is located and a neighboring cell; and
in response to that the beam footprint where the user equipment is located has entered the overlapping coverage area between the cell where the user equipment is located and the neighboring cell, selecting, by the user equipment, a beam corresponding to a specific beam index as the serving beam, wherein the specific beam index is a beam index that the user equipment receives in the overlapping coverage area and that is within a range of the reserved beam indices.

6. The beam management method according to claim 5, further comprising:
determining, by the user equipment, whether the beam footprint where the user equipment is located has exited the overlapping coverage area between the cell where the user equipment is located and the neighboring cell;
in response to that the beam footprint where the user equipment is located has exited the overlapping coverage area between the cell where the user equipment is located and the neighboring cell, determining, by the user equipment, whether the beam footprint where the user equipment is located has changed; and
in response to that the beam footprint where the user equipment is located has not changed, re-selecting, by the user equipment, the beam corresponding to the target beam index as the serving beam.

7. The beam management method according to claim 6, further comprising:
in response to that the beam footprint where the user equipment is located has changed, determining, by the user equipment according to the beam deployment map, a new target beam index corresponding to the changed beam footprint where the user equipment is located; and
selecting, by the user equipment from the cell where the user equipment is located, a beam corresponding to the new target beam index as the serving beam.

8. The beam management method according to claim 5, further comprising:
receiving, by the user equipment, a system message transmitted by a network device of the satellite network, and the system message carrying the range of the reserved beam indices.

9. The beam management method according to claim 3, wherein the edge beam footprints comprise front and/or rear edge beam footprints in a movement direction of the cell where the user equipment is located.

10. The beam management method according to claim 3, wherein the beam deployment map is pre-configured in the user equipment.

11. The beam management method according to claim 10, further comprising:
receiving, by the user equipment, map update data transmitted by a network device of the satellite network; and
updating, by the user equipment, a local beam deployment map based on the map update data.

12. The beam management method according to claim 1, wherein the step of acquiring, by a user equipment, a serving beam corresponding to a beam footprint where the user equipment is located comprises:
receiving, by the user equipment, the serving beam designated by a network device of the satellite network for the beam footprint where the user equipment is located, wherein the target beam index is determined by the network device according to the beam footprint where the user equipment is located and a beam deployment map.

13. A beam management method, comprising the following steps:
determining, by a network device according to a beam deployment map, target beam indices corresponding to beam footprints covered by its cell, wherein each beam footprint is bound to one beam index; and
transmitting, by the network device, beams according to the target beam indices.

14. The beam management method according to claim 13, wherein there is an overlapping coverage area between adjacent cells of the satellite network, a first part of beam indices of a satellite network serve as reserved beam indices for allocation to edge beam footprints corresponding to the overlapping coverage area, and a second part of beam indices of the satellite network are fixedly allocated to beam footprints in a beam deployment map.

15. The beam management method according to claim 13, wherein there is no overlapping coverage area between adjacent cells of a satellite network, and all beam indices of the satellite network are fixedly allocated to beam footprints in a beam deployment map.

16. The beam management method according to claim 14, wherein the step of transmitting, by the network device, beams according to the target beam indices comprises:
transmitting, by the network device according to allocation information of the reserved beam indices, beams to the edge beam footprints covered by its cell, and transmitting, by the network device according to the target beam indices, beams to the remaining beam footprints covered by its cell.

17. The beam management method according to claim 14, further comprising:
broadcasting, by the network device, a system message to the beam footprints covered by its cell, wherein the system message carries a range of the reserved beam indices.

18. The beam management method according to claim 14, further comprising:
receiving, by the network device, map update data transmitted by a ground control center of the satellite network; and
broadcasting, by the network device, the map update data to the beam footprints covered by the cell.

19. A user equipment, comprising:
at least one processor; and
at least one memory storing thereon instructions that, when executed individually or collectively by the at least one processor, cause the user equipment to execute the beam management method comprising the following steps:
acquiring a serving beam corresponding to a beam footprint where the user equipment is located, wherein the serving beam is a beam corresponding to a target beam index in a satellite network, and each beam footprint is bound to one beam index.

20. A computer storage medium storing thereon instructions, wherein when executed individually or collectively by at least one processor of a computer device, the instructions cause the computer device to execute the beam management method of claim 1.
